(19) United States
(12) Patent Application Publication
(10) Pub. No.: US 2004/0036417 A1
(43) Pub. Date: Feb. 26, 2004

(54) Lamp housing with integral circuit grid

(75) Inventor: Tra H. Goss, Noblesville, IN (US)

Correspondence Address: James D. Wood, ICE MILLER, One American Square, Box 82001, Indianapolis, IN, 46282-0002, US

(73) Assignee: GUIDE CORPORATION, Pendleton, IN

(21) Appl. No.: 10/223,939

(22) Filed: Aug. 20, 2002

(51) Int. Cl. H01K 1/62

(52) U.S. Cl. 315/56; 315/60

(57) ABSTRACT

The present invention comprises a lamp assembly with an integral circuit to provide electrical connectivity to the lamp and methods of making the lamp assembly. The integral circuit in one embodiment is constructed from a conductive polymer. The polymer may be injection molded, and the lamp assembly housing and integral circuit may be manufactured using a two-shot injection molding process. The present invention may be used in the production of a wide range of lamp assemblies, including vehicle headlamp assemblies.

### FIELD OF THE INVENTION

This invention relates to vehicle lighting assemblies and, in particular, to a novel lamp assembly with an integral circuit grid.

### BACKGROUND OF THE INVENTION

Generally, vehicles, especially automobiles, are equipped with a wide variety of lights serving many different purposes. These purposes include dashboard lighting, interior overhead lighting, exterior lighting, trunk lighting and under-hood lighting, to name only a few. An even wider variety of lighting needs are presented by boats, air planes and other vehicles. In each of these situations, a light source, such as a vehicle lamp, must be electrically connected to the vehicle's power source via some type of electrical connection system (“electrical connection”). Because a large number of electrical connections may be included in a vehicle, a small savings in cost per electrical connection can translate into a significant savings for the overall vehicle cost.

Furthermore, each electrical connection must be assembled into the vehicle and connected to the vehicle power source. Of course, every step in the assembly and connection process adds time, complexity and expense to the manufacturing process. Thus, a reduction in the number of steps needed to accomplish assembly and connection has a direct impact on lowering the manufacturing time and costs of the vehicle.

Similarly, the manufacturing cost of the electrical connection has a direct impact on the overall cost of a vehicle. Thus, as the process of manufacturing the electrical connection is simplified, the cost of manufacturing can be reduced as increased manufacturing efficiency is realized.

Throughout the above processes, quality is an important consideration. The electrical connection must be sufficiently robust that the electrical connection performance is not degraded by mishandling during manufacture, shipment and assembly processes. Furthermore, depending on the application, electrical connections must function reliably under severe operational conditions such as severe shock and vibration, a wide range of temperature, and exposure to water, oil and dirt.

Conventional electrical connections for lamp assemblies include a plug which holds the lamp light bulb, and a wire harness that connects to the plug on one end, and to the vehicle's power distribution bus at the opposite end. Depending on the application, a number of wire harnesses may be used to connect a particular lamp to the power distribution bus.

Conventional electrical connections have several disadvantages. For example, each plug portion of the wire harness requires a plastic or rubber exterior and metal interior connection elements, increasing the direct cost of the electrical connection. Furthermore, there are additional costs associated with stocking the increased number of parts. Moreover, each additional plug increases manufacturing costs and increases the complexity of the assembly process.

Additional shortcomings of wire harnesses in electrical connections arise in vehicular applications. In modern vehicles, the engine compartment and surrounding space has become increasingly filled by various components. Therefore, space is at a premium. Wire harnesses, however, tend to be bulky and difficult to manipulate. This is a significant disadvantage when the wire harness is to be used in the constrained space of modern vehicles, representing both a design problem (to design sufficient space) as well as a manufacturing problem (forming the wire harness into the designed space).

The design and manufacturing challenges contribute to reduced reliability of conventional electrical connections in a variety of ways. The cramped space available for assembling the wire harness into the vehicle can result in poor engagement of the wire harness plugs. When subjected to normal shock and vibration, the plugs can then become disengaged. It is known in the art to provide locking tabs on plugs to prevent such disengagement, but doing so adds additional material and additional steps to the manufacturing process, thus making the plug components even more expensive. Additionally, manipulating the wire harness into a cramped area may subject the internal wires to stresses resulting in breakage of the wires or a loss of connection between the wires and the plugs.

Yet another consequence of the cramped space into which wire harnesses are fit is the increased potential for creation of an electrical short. The wire harness will frequently be in contact with other surfaces once installed in a vehicle. As the vehicle is shocked and vibrates, the wire harness will rub against the other surfaces, fraying the insulating material. A breach of this insulation presents a substantial risk of electricity arcing from the exposed wire to other parts of the vehicle. Of course, a more robust insulation results in a bulkier wire harness, presenting increased manufacturing and design costs.

It is desirable, therefore, to provide an electrical connection for a vehicle lamp which is inexpensive and simple to manufacture. It is further desired that the electrical connection be simple to assemble into a vehicle and reliable in a wide range of environmental conditions including shock, vibration, the presence of oil, dirt and water, and temperature extremes while being easily configured to fit within space confines of a variety of vehicle designs. Moreover, it is desirable that the electrical connection minimize the risk of electrical shorts.

### BRIEF SUMMARY OF THE INVENTION

In accordance with the present invention, an electrical connection is provided which overcomes the disadvantages of the prior art by providing an electrical connection which comprises a circuit grid integrally formed on the outer surface of a lamp housing. According to one embodiment of the invention, a plug is provided which is in electrical communication with the circuit grid and pluggably connectable to the power distribution bus of a vehicle. The invention provides an electrical connection which is inexpensive and simple to manufacture. The invention further allows for simple assembly into a vehicle while remaining reliable in a wide range of environmental conditions including shock, vibration, the presence of oil, dirt and water, and temperature extremes. Because of the reduced size and absence of a wire harness, the invention is easily configured to fit within space confines of a variety of vehicle designs. Moreover, the invention minimizes the risk of electrical shorts.

### BRIEF DESCRIPTION OF THE DRAWINGS

FIG. 1 is a vehicle lighting assembly housing in accordance with an exemplary embodiment of the present invention.

FIG. 2 is a schematic top plan view of the lighting assembly housing of FIG. 1.

FIG. 3 is a schematic rear plan view of the lighting assembly housing of FIGS. 1 and 2.

### DETAILED DESCRIPTION OF THE INVENTION

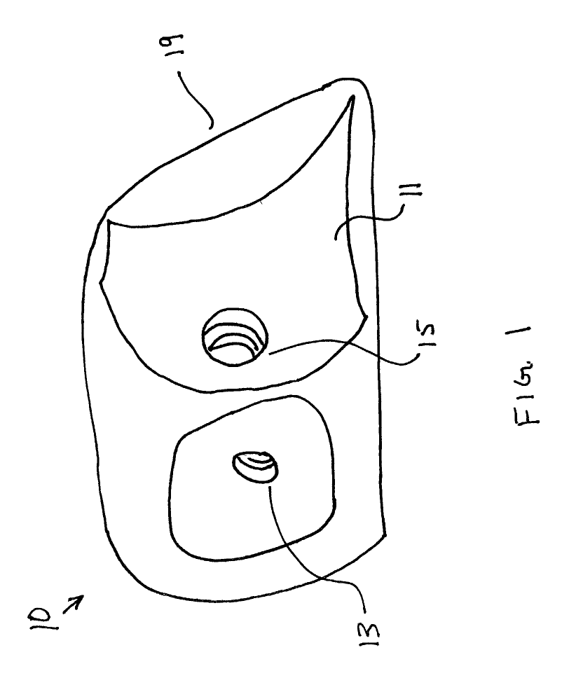

An exemplary embodiment of the present invention is described in reference to FIG. 1. FIG. 1 generally illustrates vehicle lamp housing assembly 10 which provides for forward and signal marker light functionality. The view of FIG. 1 is generally representative of a view at an angle outboard of the center line of the vehicle on the passenger side thereof. The portion of housing assembly 10 to the right in FIG. 1 is associated with the provision of a substantially forwardly projected light beam while the portion of housing assembly 10 to the left in FIG. 1 is associated with the provision of a substantially side facing signal marker lamp.

The forward lighting portion of housing assembly 10 includes reflector 11 which conventionally is provided for by a metalization layer on a parabolic or semi-parabolic portion of housing 10. Housing 10 may be comprised of, for example, a conventional polycarbonate material fabricated by known injection molding processes. Forward bulb socket key-way 15 is provided at the base of parabolic headlight reflector 11 for assembly of a bulb and bulb socket (not shown) into the posterior of the housing. In spaced adjacency to the forward portion and off-axis thereto is signal bulb socket key-way 13. Forward bulb socket key-way 15 and signal bulb socket key-way 13 provide a means for fixing a light emitting device within housing 10.

The entire housing assembly 10 generally turns a radius which sweeps the housing assembly around the front corner of the vehicle such that the forward portion generally projects forward of the vehicle and the signal lamp portion is generally most visible from a side viewing angle relative to the vehicle. Housing 10 has associated therewith sidewall 19 generally delimiting housing 10.

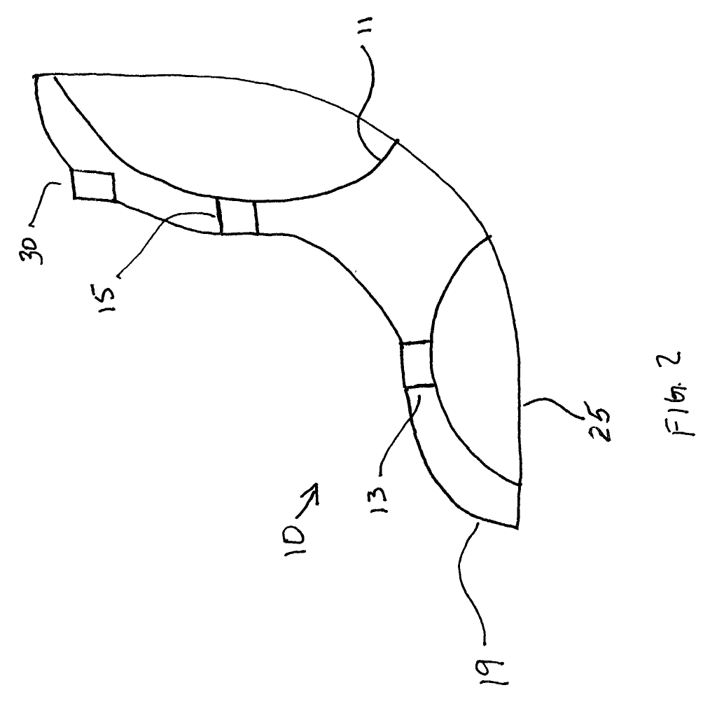

Referring now to FIG. 2, light-transmissive lens cover 25 generally follows the contour of housing 10. The lens assembly may be comprised of, for example, an acrylic material fabricated by known injection molding processes. Plug 30, which is in electrical communication with signal bulb socket key-way 13 and forward bulb socket key-way 15, in this embodiment provides a means for electrical connection to vehicle power. Plug 30 in this exemplary embodiment is of the type model 1535520, available from Delphi Packard Electric Systems of Warren Ohio. The particular plug to be used is not critical to the practice of the present invention. The salient characteristic of the means for electrical connection to vehicle power is that it provide electrical connectivity between a power source and the integral circuit grid described below. Accordingly, means for electrical connection to vehicle power may include plugs which are connected to housing 10, or even plugs which are integral to housing 10. These and other alternative embodiments being within the scope of the present invention.

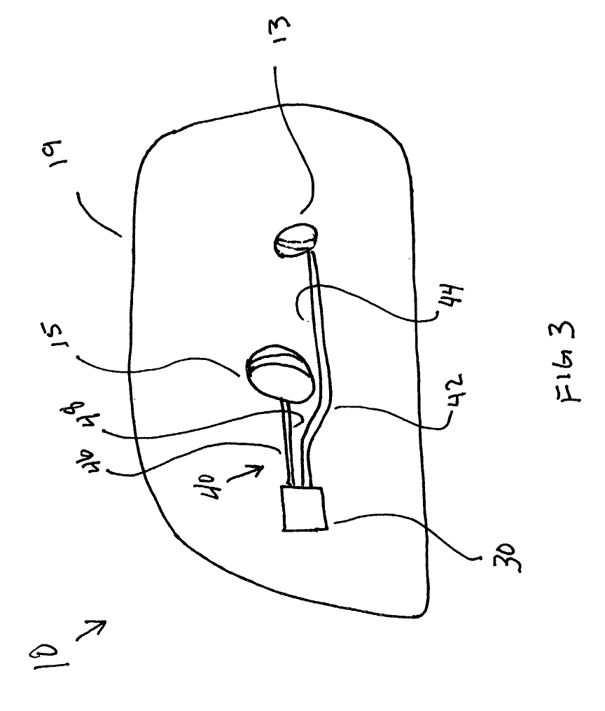

Referring now to FIG. 3, housing 10 is shown from a rear perspective so as to illustrate integral circuit grid 40. Integral circuit grid 40 provides electrical connectivity between signal bulb socket key-way 13 and plug 30 by conductive moldings 42 and 44. Integral circuit grid 40 further provides electrical connectivity between forward bulb socket key-way 15 and plug 30 by conductive moldings 46 and 48. Conductive moldings 42, 44, 46 and 48 in this embodiment may be disposed on the outside of housing 10, via screen printing, electroplating, “two-shot” injection molding, or other means known in the art for adhering integral circuit grid 40 to housing 10. Integral circuit grid 40 may be composed of any electrically conductive polymer such as LEXAN SP7750 commercially available from GE Plastics, Pittsfield, Pa.

Those of skill in the relevant art will appreciate that the amount of any such polymer may be modified so as to provide for passing the amount of current needed by the lamp being powered. Moreover, those of skill in the art will recognize that a variety of grids may be produced according to the present invention. A grid may comprise a single conductive line, or a plurality of lines. Furthermore, the conductive lines need not be of uniform shape or size. Additionally, although the invention has been described above with respect to a single exemplary embodiment including two sockets, those of skill in the art will recognize that the present invention is not so limited, being suitable for practice with a variety of numbers and types of light emitting devices including, without limitation, luminescent lamps, incandescent lamps and light emitting diodes. These and other embodiments being within the scope of the present invention.

According to alternative embodiments of the present invention, the conductive moldings further provide a means for fixing a light emitting device within housing 10. According to one such embodiment, a light emitting diode (LED) is electrically connected to the conductive moldings, the conductive moldings providing the dual functions of providing an electrical connection and providing mechanical support for the LED.

Those of skill in the art will realize that as described herein, the present invention provides significant advantages over the prior art. The invention provides an electrical connection which is inexpensive and simple to manufacture. The invention further allows for simple assembly into a vehicle while remaining reliable in a wide range of environmental conditions including shock, vibration, the presence of oil, dirt and water, and temperature extremes. Because of the reduced size and absence of a wire harness, the invention is easily configured to fit within space confines of a variety of vehicle designs. Moreover, the invention minimizes the risk of electrical shorts. Other objects and features of the present invention will be apparent to those of skill in the art in consideration of the above description, the accompanying drawings, and the following claims.

While the present invention has been described in detail with reference to a certain exemplary embodiment thereof, such is offered by way of non-limiting example of the invention, as other versions are possible. It is anticipated that a variety of other modifications and changes will be apparent to those having ordinary skill in the art and that such modifications and changes are intended to be encompassed within the spirit and scope of the invention as defined by the following claims.

I claim:

1. A lamp assembly, comprising:
a housing;
a means for fixing at least one light emitting device within the housing;
at least one light emitting device; and
an integral circuit grid, the integral circuit grid in electrical communication with the light emitting device.

2. The lamp assembly of claim 1, wherein the integral circuit grid comprises a single electrically conductive line.

3. The lamp assembly of claim 1, wherein,
the means for fixing at least one light emitting device within the housing comprises means for fixing a plurality of light emitting devices within the housing,
the at least one light emitting device comprises a plurality of light emitting devices, and
the integral circuit grid comprises a plurality of electrically conductive lines, the plurality of electrically conductive lines in electrical communication with the plurality of light emitting devices.

4. The lamp assembly of claim 1, wherein the integral circuit grid comprises the means for fixing at least one light emitting device within the housing.

5. The lamp assembly of claim 1 further comprising a means for electrical connection to vehicle power, the means for electrical connection to vehicle power in electrical communication with the integral circuit grid.

6. The lamp assembly of claim 5, wherein the means for electrical connection to vehicle power is integral to the housing.

7. The lamp assembly of claim 6, wherein the integral circuit grid comprises the means for electrical connection to vehicle power.

8. The lamp assembly of claim 1, the housing and the integral circuit grid being manufactured as a single two-shot injection molded unit.

9. The lamp assembly of claim 8, wherein the integral circuit grid comprises a conductive polymer.

10. The lamp assembly of claim 1, wherein the integral circuit grid comprises a conductive polymer, the integral grid being formed by screen printing, electroplating, or injection molding.

11. A method of making a lamp assembly, comprising the steps of:
forming a housing;
forming within the housing a means for fixing at least one light emitting device; and
forming a circuit grid integral to the housing, the integral circuit grid in electrical communication with the light emitting device.

12. The method of claim 11, wherein the step of forming a circuit grid integral to the housing comprises the step of forming a single electrically conductive line.

13. The method of claim 11, wherein the step of forming within the housing a means for fixing at least one light emitting device comprises the step of
forming within the housing a means for fixing a plurality of light emitting devices.

14. The method of claim 11, wherein the step of forming within the housing a means for fixing at least one light emitting device comprises the step of forming a circuit grid integral to the housing.

15. The method of claim 11 further comprising the step of
providing a means for electrical connection to vehicle power, the means for electrical connection to vehicle power in electrical communication with the integral circuit grid.

16. The method of claim 15, wherein the step of providing a means for electrical connection to vehicle power comprises the step of providing a means for electrical connection to vehicle power integral to the housing.

17. The method of claim 16, wherein the step of providing a means for electrical connection to vehicle power integral to the housing comprises the step of forming a circuit grid integral to the housing.

18. The method of claim 11, wherein the steps of forming a housing and forming a circuit grid integral to the housing, are performed by a two-shot injection molding process.

19. The method of claim 18, wherein the step of forming a circuit grid integral to the housing comprises the step of forming an integral circuit grid comprising a conductive polymer.

20. The method of claim 11, wherein the step of forming a circuit grid integral to the housing comprises the step of forming an integral circuit grid by screen printing, electroplating, or injection molding.
